(19) United States
(12) Patent Application Publication
(10) Pub. No.: US 2022/0271914 A1
(43) Pub. Date: Aug. 25, 2022

(54) System and Method for Providing a Secure, Collaborative, and Distributed Computing Environment as well as a Repository for Secure Data Storage and Sharing

(71) Applicant: Govermment of the United of America as represented by the Secretary of the Navy, San Diego, CA (US)

(72) Inventors: Mamadou H. Diallo, San Diego, CA (US); Michael A. August, San Diego, CA (US); Verinder Rana, San Diego, CA (US); Christopher T. Graves, San Diego, CA (US); Scott M. Slayback, San Diego, CA (US); Kevin T. Groarke, San Diego, CA (US)

(21) Appl. No.: 17/183,499

(22) Filed: Feb. 24, 2021

(51) Int. Cl. H04L 9/00; H04L 9/08; H04L 9/06; H04L 29/08; G06N 20/00

(52) U.S. Cl. CPC H04L 9/008; H04L 9/0825; H04L 9/0894; H04L 9/065; H04L 67/1097; G06N 20/00

(57) ABSTRACT

A system for providing a secure, collaborative, and distributed computing environment as well as a repository for secure data storage and sharing, the system comprising: FHE manager software residing on a trusted client computer that is configured to generate and store encryption and decryption keys in a memory store; configurations manager software residing on the trusted client computer that is configured to track dynamically-changing cloud resources; an untrusted server in an untrusted cloud environment; a plurality of untrusted, physical, distributed processing nodes where no decryption or encryption functions occur at the processing nodes; a machine learning (ML) manager configured to manage ML algorithms in the processing nodes, wherein the untrusted server is permitted to perform cloud management but not trusted to manipulate the data in plaintext thereby enabling collaborative and secure processing, editing, and merging of the data.

### FEDERALLY-SPONSORED RESEARCH AND DEVELOPMENT

The United States Government has ownership rights in this invention. Licensing and technical inquiries may be directed to the Office of Research and Technical Applications, Naval Information Warfare Center Pacific, Code 72120, San Diego, Calif, 92152; voice (619) 553-5118; ssc_pac_t2@navy.mil. Reference Navy Case Number 111674.

### BACKGROUND OF THE INVENTION

Performing big data analytics in the cloud is becoming an increasingly significant tool for organizations of all types and sizes. These data analytics can be used to gain powerful insights out of the ever-growing pools of organizational data. The cloud provides the scalable infrastructure and resources needed to efficiently run the analytic tools necessary to gain insights on big data. However, threats on data privacy in the cloud are growing at a fast pace. Cybersecurity attacks on data in large organizations are occurring more frequently. The major security drawback of the cloud is the fact that computation on data requires it to be in plaintext format. The recommended standard encryption schemes, such as the advanced encryption standard (AES) or Blowfish, provide strong protection of data in transit and at rest, but do not support operations to be performed directly on the encrypted data. This means that data needs to be decrypted in memory before processing of the data can take place, which leaves the data vulnerable to attacks from both insider and outsider threats.

To address this shortcoming of existing standard cryptographic schemes, homomorphic encryption (HE) schemes have been proposed. These techniques have revolutionized data security as they enable computation to be performed directly on the protected data without needing the private keys used to encrypt the data. However, these HE techniques, while significantly improving data security in untrusted environments, come with significant computation and storage costs. The computational complexity of HE in general is orders of magnitude higher. A given ciphertext encoding is also much larger than its corresponding plaintext. There is a need for an improved system and method for securely and efficiently processing encrypted data.

### SUMMARY

Described herein is a system for providing a secure, collaborative, and distributed computing environment as well as a repository for secure data storage and sharing. The system comprises a trusted client computer and an untrusted computing environment. The trusted client computer comprises a client manager, a fully homomorphic encryption (FHE) manager, and a configurations manager. The client manager is software residing on the trusted client computer that is configured to manage all activities of the trusted client computer. The FHE manager is software residing on the trusted client computer that is configured to generate and store encryption and decryption keys in a memory store. The FHE manager is also configured to perform all encryption and decryption functions on data. The configurations manager is software residing on the trusted client computer that is configured to track dynamically-changing cloud resources as the system is in use. The untrusted computing environment comprises an untrusted server and a plurality of untrusted, physical, distributed processing nodes. The untrusted server comprises a distributed engine, an FHE manager, a machine learning (ML) manager, a sharing manager, and a configurations database. The FHE manager is configured to manage FHE processing operations in the processing nodes where no decryption or encryption functions occur at the processing nodes. The ML manager is configured to manage ML algorithms in the processing nodes. The sharing manager is configured to share encrypted data with the processing nodes and the trusted client computer. The untrusted server is permitted to perform cloud management but not trusted to manipulate the data in plaintext thereby enabling collaborative and secure processing, editing, and merging of the data.

Also described herein is a method for increasing the speed of secure encrypted computing of big data in a cloud environment comprising the following steps. The first step provides for modifying a machine learning, big data analytics engine to ensure that serialization and deserialization of cipher texts and context objects is performed such that the machine learning, big data analytics engine is configured to communicate with a homomorphic encryption software library so that the machine learning, big data analytics engines serves as a distributed machine learning library that is configured to perform machine learning and data analytics on the big data in the cloud. The next step provides for modifying the homomorphic encryption software library to enable it to communicate with a plurality of computer nodes in the cloud environment such that the homomorphic encryption software library is not optimized for single node computations but is configured to impose FHE on a segment of the big data. The homomorphic encryption software library is used as a core lattice cryptography library. Another step in this embodiment provides for using the distributed machine learning library and core lattice cryptography library to perform computations on the FHE data by implementing a support vector machine (SVM) algorithm to analyze the FHE data for classification and regression analysis on the plurality of computer nodes thereby enabling SVM classification on a large encrypted data set in a distributed fashion.

Another embodiment of the system for providing collaborative and secure data processing, editing, and merging as well as a repository for secure data storage and sharing may be described as comprising a first trusted computer client, an untrusted cloud environment, and a second trusted computer client. The first trusted computer client comprises an FHE manager configured to create FHE data. The untrusted cloud environment comprises an untrusted server communicatively coupled to a plurality of distributed, untrusted computer nodes. The second trusted computer client comprises an FHE manager configured to decrypt FHE data. The untrusted server comprises a machine learning analytics engine that is communicatively coupled to a homomorphic encryption software library. The untrusted server is configured to distribute at least a portion of the FHE data to the plurality of distributed untrusted computer nodes. The untrusted computer nodes are configured to perform data analytics in parallel directly on the FHE data without decrypting the FHE data. The encrypted results of the data analytics are transmitted to the second trusted computer client via the untrusted server. The second trusted computer client is configured to decrypt the encrypted results. The first trusted computer client further comprises a cryptographic key manager that is configured to make use of a key management system based on public key infrastructure (PKI) in order to generate, store, distribute, and revoke public keys with respect to the untrusted cloud environment and to generate, store, distribute, and revoke private keys with respect to the second trusted computer client. Each of the first and second trusted computer clients further comprises an email server so as to enable an exchange of private keys between the first and second trusted computer clients using an email infrastructure.

### BRIEF DESCRIPTION OF THE DRAWINGS

Throughout the several views, like elements are referenced using like references. The elements in the figures are not drawn to scale and some dimensions are exaggerated for clarity.

FIG. 1 is a block diagram of a system for providing a secure, collaborative, and distributed computing environment as well as a repository for secure data storage and sharing.

FIG. 2 is a block diagram of two example trusted computer clients and an untrusted server.

### DETAILED DESCRIPTION OF EMBODIMENTS

The disclosed methods and systems below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other methods and systems described herein as will be understood by one of ordinary skill in the art unless otherwise stated specifically.

Described herein is a system for providing a secure, collaborative, and distributed computing environment as well as a repository for secure data storage and sharing. The system, which is described in more detail below, makes use of FHE to enable secure computation to be performed on distributed processing nodes in a distributed, untrusted, cloud computing environment, which enables operations to be performed directly on encrypted data without using the private decryption key. Using FHE, the system can distribute homomorphically encrypted data and analytics into untrusted processing nodes of the untrusted computing environment and allow the analytics to operate on the encrypted data in each node. The system also utilizes various machine learning (ML) algorithms in the nodes and a key management infrastructure to enable the sharing of data privately between trusted computers. Having access to different ML algorithms, homomorphic encryption libraries, and homomorphic encryption schemes will enable end-users to tradeoff between the quality of the data analysis and the time it takes to perform the analysis. Embodiments of the system enable users to not only contribute to the pool of data processing in the cloud, but also make it possible to collaborate in the processing of the data. The system provides a unique way to attach ML techniques to a parallelization framework in the cloud.

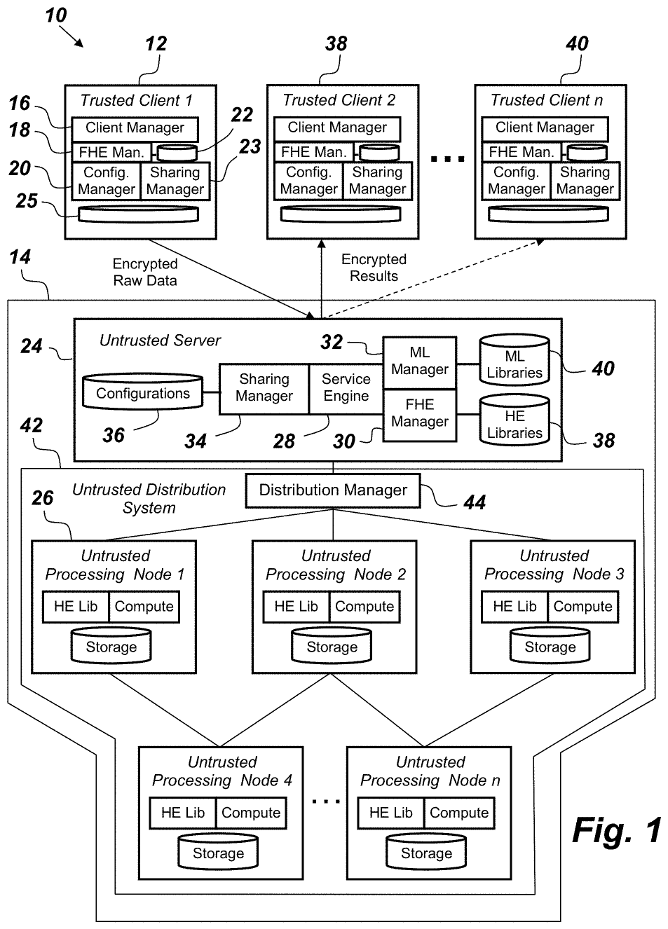

FIG. 1 is a block diagram of a system 10 for providing a secure, collaborative, and distributed computing environment as well as a repository for secure data storage and sharing. The system 10 comprises trusted client computers 12, 38, and 40 and an untrusted computing environment 14 . Each of the trusted client computers 12, 38, and 40 comprises a client manager 16, a fully homomorphic encryption (FHE) manager 18, a configurations manager 20, a memory store 22, a sharing manger 23, and an encrypted data database 25. The client manager 16 is software residing on the trusted client computer 12 that is configured to manage all activities of the trusted client computer 12. The FHE manager 18 is software residing on the trusted client computer 12 that is configured to generate and store encryption and decryption keys in a memory store 22. The FHE manager 18 is also configured to perform all encryption and decryption functions on data. The configurations manager 20 is software residing on the trusted client computer 12 that is configured to track dynamically-changing cloud resources as the system 10 is in use. The untrusted computing environment 14 comprises an untrusted server 24 and a plurality of untrusted, physical, distributed processing nodes 26. The untrusted server 24 comprises a distributed engine 28, an FHE manager 30, a machine learning (ML) manager 32, a sharing manager 34, and a configurations database 36. The FHE manager 30 is configured to manage FHE processing operations in the processing nodes 26 where no decryption or encryption functions occur at the processing nodes 26. The ML manager is configured to manage ML algorithms in the processing nodes. The sharing manager 34 is configured to share encrypted data with the processing nodes 26 and the trusted client computer 12. The untrusted server 24 is permitted to perform cloud management but not trusted to manipulate the data in plaintext thereby enabling collaborative and secure processing, editing, and merging of the data.

System 10 leverages FHE to provide data security for cloud analytics not only in transit and at rest, but most importantly, when being processed. System 10 also provides mechanisms for incorporating data analytic tools that use FHE schemes into the nodes of the distributed computing environment. This enables data analytic tools to operate directly on the encrypted data. Through inclusion of a cryptographic key management infrastructure, system 10 enables data sharing between the trusted computer client 12 and other trusted computer clients 2 through n, identified by reference characters 38 and 40 respectively. In order to generate, store, distribute, and revoke public keys with respect to the untrusted cloud environment 14 and to generate, store, distribute, and revoke private keys with respect to other trusted computer clients 1-n, the cryptographic key management infrastructure may be based on PKI such as is described in the paper “Cloudprotect: Managing data privacy in cloud applications” by M. H. Diallo, B. Hore, E. Chang, S. Mehrotra, and N. Venkatasubramanian in 2012 IEEE Fifth International Conference on Cloud Computing, June 2012, pp. 303-310 (hereinafter referred to as the Cloudprotect Paper), which paper is incorporated by reference herein. System 10 may be utilized to enable an organization to analyze data in the cloud and share the results with other organizations. Distributing analytic tool execution into the nodes of the framework speeds up the expensive operations of the FHE schemes to improve the overall performance of the tools. System 10 enables tool developers using various ML and data mining algorithms to build analytic tools.

The following is a description of example FHE schemes that may used by system 10. One FHE scheme is an FHE scheme based on ring learning with errors (RLWE). This scheme is hereinafter referred to as the RLWE scheme. The security of the RLWE scheme is based on the hardness of the Ring RLWE problem. The RLWE problem has been proven to provide a strong security guarantee while supporting more practical FHE schemes. The RLWE problem may be defined as follows. Definition of RLWE: let n=2k and choose a prime modulus q such that q≡1 mod 2n. Let the ring R_{q}= [symbol] _{q}[x]/(xⁿ+1) represent the set of all the polynomials over the finite field [symbol] _{q} for which xⁿ≡−1. Given samples of the form (a, b=a×s+e) ∈ R_{q}×R_{q} where s ∈ R_{q} is a fixed secret vector, an element a ∈ R_{q} is chosen uniformly, and e is chosen randomly from an error distribution in R_{q}. Given this definition of the RLWE problem, finding s is infeasible. Using the RLWE problem, a message m ∈ R_{q} can be encrypted by using the b element above as a one-time pad encryption scheme. The ciphertext can be represented by c=b+m; where c ∈ R_{q}. Another FHE scheme is the BGV scheme, short for authors Brakerski, Gentry, and Vaikuntanathan. The BGV scheme is referred to as “leveled” due to the fact that its parameters depend (polynomially) on the depth of the circuits that it is capable of evaluating. “Leveled” FHE means that the size of the public key is linear in the depth of the circuits that the scheme can evaluate, that is, its size is not constant. The key operation in the BGV scheme is the REFRESH procedure, which switches the moduli of the lattice structure and switches the key. Any FHE scheme known in the art may be used with the system 10.

Software libraries implementing the FHE schemes have been developed. One of such libraries is HElib. One example library that may be used with an embodiment of the system 10 is the PALISADE library. The PALISADE library is being developed under an opensource project that provides efficient implementations of lattice cryptography building blocks and leading homomorphic encryption schemes. PALISADE is designed for usability, providing simpler application program interfaces (APIs), modularity and cross-platform support. The current version of PALISADE supports various FHE schemes. Another suitable example FHE library that may be used with the system 10 is the Microsoft SEAL open-source library, which provides an efficient implementation of lattice cryptography using leading homomorphic encryption schemes. The current version of SEAL also supports various FHE schemes. In one embodiment of the system 10 two FHE libraries are integrated. The following is a detailed description of this embodiment of the system 10 where the PALISADE and SEAL libraries are integrated into the system 10. Also described below are examples of data processing algorithms that may be used in system 10, an example data sharing protocol that may be used to enable clients to share encrypted data, and an example threat model of a given example embodiment of system 10.

One embodiment of system 10 is designed using a hybrid client-server/distributed model, where clients send requests to a remote server (such as the untrusted server 24 shown in FIG. 1), and the server forwards the client's requests to a distributed system (i.e., the processing nodes 26) for processing. The results of the data processing are returned to the remote server 24 for storage and to be made available to the trusted computer clients 12. The high-level design of this embodiment of the system 10 is presented in FIG. 1. The architecture is composed of two main components: the trusted client computers 12 and the untrusted computing environment 14. Each trusted client computer 12 comprises three main sub components: the client manager 16, the FHE manager 18, and configurations manager 20. The client manager 16 coordinates the activities of the trusted computer client 12 and manages the interactions with the untrusted server 24. The FHE manager 18 provides support for HE operations including generation and storage of public and private keys, encryption and decryption of data, and keys revocation. The configurations manager 20 keeps track of the cloud resources for the trusted client computer(s) 12, which resources change dynamically as the system 10 is being used. Concrete systems for specific application domains may be built by those having ordinary skill in the art for use with the system 10. In addition to the above core components, system 10 may include a user interface (not shown) for end-users to interact with the system 10.

The untrusted cloud environment (i.e., the untrusted computing environment 14) is composed of the untrusted server 24 and an untrusted distribution system 42, which comprises an untrusted distribution manager 44 and the untrusted processing nodes 26. All the data sets sent by the trusted client computer 12 to the untrusted computing environment 14 will remain encrypted at all times until it is decrypted by a trusted client computer 12. The subcomponents of the untrusted server 24 include the distributed service engine 28 for coordinating all the activities related to distributing data and operations into the untrusted computing system 14; the FHE manager 30 for managing HE libraries stored in the HE libraries storage 38; the analytics or ML manager 32 for managing the analytic algorithms stored in the ML libraries storage 40; the sharing manager 34 for sharing encrypted data between the processing nodes 26; and a configurations storage database 36 for storing various cloud configurations and metadata of the untrusted computing environment 14. The service engine 28 communicates with the untrusted processing nodes 26 to coordinate their activities, including sending workloads and partitioning the nodes 26 within a given cluster.

The untrusted distribution system 42 provides the infrastructure for distributing analytics algorithms to the processing nodes 26. The inputs to the untrusted distribution system 42 include the set of data to be processed and the software program to be executed on the nodes 26 of the distributed system that will process the data. At the core of the distributed system 42 is the distribution manager 44, which provides the mechanisms for generating the clusters of distributed nodes 26. The nodes 26 are generated by the distribution manager 44 on demand based on the configurations provided by users of the system 10. In addition, the untrusted distribution system 42 provides an interface to enable interaction with other distributed systems.

At the core of system 10 is the mechanism for incorporating HE libraries into the framework. Like the standard cryptographic algorithms, homomorphic encryption algorithms have a well-defined set of operations. These operations include key generation, encryption, decryption, and ciphertext operations. To accommodate various FHE libraries, system 10 abstracts out the common core operations of HE libraries and builds those operations into the framework. It adopts a parameterization approach to enable each library to provide all necessary parameters to execute the operations. At a low-level of the implementation, a binary operation takes as inputs two integers A and B, and returns the result as an integer C. These operations are abstracted out into an interface that can then be used to integrate a given HE library. As part of this embodiment of system 10, we integrated the PALISADE and SEAL libraries.

System 10 provides an extensible interface to enable developers to extend or customize system 10 to add new machine learning and data mining algorithms into system 10. Considering the complexity of using existing HE libraries, one example ML algorithm that may be used in system 10 is the linear Support Vector Machine (SVM) algorithm. Another suitable example of an ML algorithm that may be implemented within the system 10 is an artificial neural network. However, it is to be understood that system 10 is not limited to the two ML algorithms mentioned above.

SVMs are supervised learning models that can be used to analyze data based on classification and regression analysis. The SVM serves as a nonprobabilistic binary linear classifier. Consider a set S of sample data elements, and two subsets S_{A} and S_{B} of S, where S_{A} ∪ S_{B}=S, and each element of S (S₁ ∈ S) is annotated as belonging to S_{A} or S_{B}. The SVM training algorithm generates a mathematical model that can be used to categorize new elements of S as belonging to S_{A} or S_{B}. First, we are given a labeled training dataset of n points of the form (\vec{x}₁, y₁), . . . , (\vec{x}ₙ, yₙ). This training dataset contains both the inputs and the desired outputs. Given the training dataset, we then compute the SVM model to be used for classification. This model then separates the elements of S into two classes, S_{A} and S_{B}, based on the classifier that was generated from the training data. The internal operations of the linear SVM include the dot product of vectors, addition, and subtraction. To demonstrate the utility of system 10, we implemented an SVM classifier on top of our distributed framework using the PALISADE library.

Neural networks are a learning mechanism that model the biological brain. They consist of a set of transformations of a signal vector throughout a graph of nodes. Each node, called a neuron, is connected to the next layer of neurons via edges, called links. Each link has a weight associated with it. Each neuron processes its input signal as a linear combination of the weights of its input neurons according to an activation function and produces an output signal that gets forwarded to neurons in the next layer of the network. The training phase constructs a model by updating the weights associated with each neuron in the network. After being constructed, the model can be represented by a mathematical function and used to classify real world inputs to the neural network. In this way, neural networks are considered a black box machine learning approach. Deep neural networks typically have many layers and utilize specialized neural network architectures. To demonstrate the applicability of the system 10 framework to parallelize an encrypted image classification task, in one embodiment, we implemented a feedforward neural network classifier on top of our distributed framework using a homomorphic encryption library.

In one embodiment of the system 10, we adopt the honest-but-curious adversarial model. We assume that the client-side is trusted while the cloud environment is untrusted. We assume that Cloud Service Providers (CSP) as well as users can act as adversaries. When users send data into the cloud, the CSP can store the data in different locations and make use of it without the user's knowledge. We assume that the CSP will not deliberately tamper with users' data by inserting, deleting, modifying, and truncating parts of the data. An adversarial CSP may not provide false answers in response to user queries. We assume that the adversarial CSP cannot obtain a user's secret keys.

In this embodiment of system 10, all users are required to register into the system to get credentials for authentication. Only users verified through authentication can gain access to the system. In addition to authentication, the framework employs a policy-based authorization service to provide access control to data. Using this service, users can decide who can get access to what parts of their encrypted data in the cloud. Homomorphic encryption schemes have been proven to be very secure. All the private keys for decrypting the data remain with clients, and only public keys are sent to the cloud.

One challenge in sharing data securely in the cloud is how to enable recipients to open the shared data. PM technology is used to authenticate users and devices against information systems. PKI relies on a Certificate Authority (CA), which acts as a trusted third party responsible for managing and certifying public keys ownership. The CA associates a given user ID with a public key by generating a signature referred to as a certificate. In this approach, all users of a system can exchange their public keys for the purpose of data sharing. In this case, a Sender wanting to share data with a Recipient would use the public key of the Recipient to encrypt the data. The Recipient would use the corresponding secret key to decrypt the data. Through the use of digital signatures, the CA can guarantee that public keys will not be subject to impersonation, where a malicious party could replace the public key of a legitimate party with a compromised one. One drawback of the PKI based data sharing is that it requires complex computations for data encryption and decryption, which can slow down systems with extensive data sharing. Another drawback is the dependency on the trusted third party CA, which increases the communication overhead in a system. The symmetric keys may be used to encrypt and decrypt data and the PKI system may be used to share the symmetric keys between the users. All sharing approaches based on PKI are exposed to the security vulnerabilities associated with a CA. If a CA is breached, the certificates can be compromised resulting in sending the data to the wrong users. System 10 uses a simple approach for data sharing in untrusted environments, which doesn't require a CA such as is described in the Cloudprotect Paper. The approach makes use of a key management system based on PKI to provide clients with mechanisms to generate, store, distribute, and revoke public/private keys in a distributed system. The approach is to exchange the private keys using an email infrastructure, where each client is equipped with a built-in email server.

There are various identity and access management (IdAM) systems that can be used to restrict access to resources in a system. Among other functionalities, these systems manage, identify, authenticate, and authorize individuals to ensure appropriate access to resources. To facilitate data sharing, each client needs to partition its data based on its sharing policies. Each partition will be encrypted using a different public/secret key pair to restrict access to the data. The sharing policies define how the data can be partitioned in such a way that the number of keys required to encrypt the data is minimized. Let's denote {c₁, c₂, . . . cₙ}, the set of all clients in the system. Let's also denote {d₁^{c}^{ᵢ}, d₂^{c}^{ᵢ}, . . . dₘ^{c}^{ᵢ}}, the set of data partitions for a given client cᵢ. Then, for each data partition dⱼ, a public/secret key pair, (pkⱼ^{c}^{ᵢ}, skⱼ^{c}^{ᵢ}), will be generated to encrypt dⱼ. This will give the client a flexible approach for sharing their data in the cloud at a fine-grained level of access control. For the purpose of sharing encryption keys, each client will create a sharing public/secret key pair (sk_{c}_{ᵢ}, pk_{c}_{ᵢ}). The first time two clients, cᵢ and cⱼ, interact in the distributed system, they exchange their public keys as follows. The client cᵢ sends a message to c, containing the tuple (Id_{c}_{ᵢ}, pk_{c}_{ᵢ}) and the client cⱼ replies with a message containing the tuple (Id_{c}_{ᵢⱼ}, pk_{c}_{ᵢⱼ}). When a sender cᵢ wants to share a data partition dⱼ with a receiver cⱼ in the distributed system, the sender needs to provide the receiver with the secret key skⱼ^{c}^{ᵢ} corresponding to pkⱼ^{c}^{ᵢ} used to encrypt the data partition dⱼ in order to decrypt it. To protect the secret key, the sender encrypts it using the receiver's sharing public key. The sender replies with the following message containing the tuple (Id_{c}_{ᵢ}, Enc(skⱼ^{c}^{ᵢ}, pk_{c}_{ⱼ})), where Enc(skⱼ^{c}^{ᵢ}, pk_{c}_{ⱼ}) means that the skⱼ^{c}^{ᵢ} is encrypted using the pk_{c}_{ⱼ}. This will guarantee that only the intended receiver can decrypt the message containing the secret key.

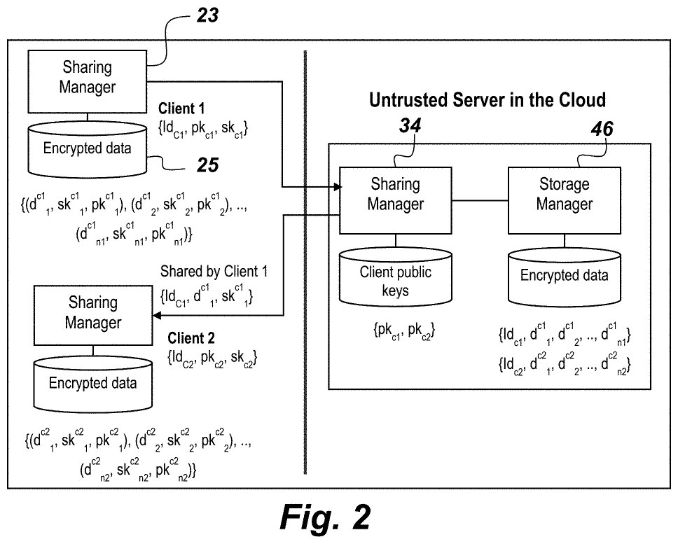

FIG. 2 is a block diagram showing an example where two trusted computer clients, c₁ and c₂, (such as 12 and 38 shown in FIG. 1) have generated public/secret key pairs, (pk_{c}_{₁}, sk_{c}_{₁}) and (pk_{c}_{₂}, sk_{c}_{₂}), for sharing secret encryption keys, partitioned their data, and generated different public/secret key pairs to encrypt each partition separately. The sharing keys for both trusted computer clients c, and c₂ are published in the cloud through the sharing manager 34 and the homomorphically encrypted data stored in the cloud through a storage manager 46. The example embodiment shown in FIG. 2 also shows the partition d₁^{c}^{₁} and its corresponding secret key sk₁^{c}^{₁}, to be used to decrypt it, received by the trusted computer client c₂ shared by the trusted computer client c₁.

The architecture of the system 10 comprises a number of components that interact to support the functionalities of the framework from the perspective of both developers and end-users. It abstracts out the complexity related to building a web-based client-server application, building a cloud-based distributed system, and connecting the two. In the following sections, we describe the operational flows of embodiments of the system 10, focusing particularly on how developers can extend the core components of system 10 and instantiate it to build concrete systems, and then discuss how end-users can use those concrete systems.

For developers extending the framework, there are two main features: adding a new HE library, and adding a new data processing algorithm based on machine learning or data mining techniques. At the design level, embodiments of system 10 may employ a modular design to isolate the HE libraries and data processing algorithms. At the implementation level, embodiments of system 10 may use containers to enable each HE library and each data processing algorithm to be self-contained. To add an HE library, the developer may deploy the HE library in a container and expose an API to enable the HE manager to make use of it. Similarly, a new data processing algorithm may be implemented and made available to the analytics manager, which will distribute it to the nodes at runtime. Both SVM and Neural Network implementations may be included in this embodiment of system 10 to serve as a guideline for developers to incorporate their own algorithms into the framework of system 10. It is to be understood that SVM and Neural Network implementations are what were used in this embodiment, but the system 10 is not limited to only these ML classification techniques.

The framework of system 10 provides building blocks that can be used to build concrete distributed systems where analytic tools can be run in the encrypted domain. The application domain will determine the specific analytic tools to be applied using one of the available HE-enabled machine learning or data mining algorithms. For instance, in the application we built to evaluate the framework, both an SVM and a Neural Network were determined to be suitable for an image classification task. During the analysis, each data point falls in one of ten classes. The application domain dictates the type of data that needs to be encoded appropriately to ensure compatibility with the data format of the underlying HE library. Recall that the HE libraries in the current embodiment support only low level operations, such as addition or multiplication of numbers. Specific data types of the application domain can be transformed in such a way that the basic operations of HE can be applied on the data.

Once an embodiment of the system 10 is completed, then it can be made available to end users. There are two main workflows of the system 10 for the end user: 1) analyzing data using an analytic tool, and 2) sharing data with other users. At a high-level, the following operational workflow depicts the process for analyzing data in the distributed system.
The User opens the Client web-based GUI.
From the Client GUI, the user uploads the raw data to the Client local storage.
The User selects the analytic tool to be used to process the raw data.
The User requests the data to be encrypted.
The Client Engine selects the appropriate HE library, and uses it to encrypt the data.
The Client Engine sends the encrypted data along with the user parameters to the Untrusted Server.
The Untrusted Server selects the number of nodes to use in the distributed system.
The Untrusted Server partitions the data according to the parameters selected by the user and pushes it to the nodes.
The Untrusted Server notifies the User after the data has been distributed.
The User requests data to be processed and forwarded to the Untrusted Server.
The Untrusted Server delegates the workload to the Distribution Manager.
The Distribution Manager initiates the data processing throughout the Untrusted Distributed System.
After the execution is completed, the Untrusted Server gathers the results from the Distribution Manager, and sends them to the User.
The Client Engine decrypts the results and displays them on a graphical user interface (GUI).

The following operational workflow summarizes the process for sharing data in the distributed system for one embodiment of the system 10. The sharing manager 34 on the untrusted server 24 is responsible for sharing encrypted data and encrypted secret keys between parties sharing data with each other. If the recipient doesn't already have the secret key to decrypt the data, then the sharing manager 34 will request the secret key from the sender, and the sender will encrypt the secret key using the recipient's sharing public key and send it to the sharing manager 34, which serves as the proxy between sender and receiver. In most cases, a user will possess a public/secret key pair to be used by the underlying sharing protocol. It is assumed that each party has the sharing public key of the receiver and that the data to be shared is stored with the storage manager 46.
From the Client GUI, the sender selects the set of data to be shared, the recipients and their sharing public keys.
The user sends the request to share the data to the untrusted server 24.
The sharing manager 34 on the untrusted server 24 passes a message to the recipient containing a reference to the stored encrypted data.
The sharing manager 34 notifies the recipients about the availability of the data.
The Recipients retrieve the shared data and use their secret keys to decrypt the data.

In this section, we describe an example Image Classifier implementation of the system 10. The Image Classifier embodiment includes two data analytic tools/machine learning algorithms for classifying images. The first analytic tool is implemented using SVM while the second analytic tool is implemented using neural networks. In practice, a number of open source projects may be used to implement the machine learning aspect of system 10. The implementation of this embodiment of system 10 is broken down into three main subsystems: Client, Cloud, and Distributed Computation. The Client subsystem is implemented as a web service, which includes a template for the web-based client interface, a web server for managing all the client services, and a database for storing encryption/decryption keys, plaintext data, ciphertext, and cloud configuration. We used the Django web framework (i.e., a high-level Python Web framework created by the Django Software Foundation) in this embodiment to implement this Client subsystem to connect all the client modules. The Django Rest Framework allows for quick development of web based representational state transfer (REST) APIs. The Cloud subsystem implements various modules to support its various services in the cloud. These services include managing HE libraries, data processing algorithms, analytics, cloud configurations, and data sharing among users. REST APIs may be used in system 10 to build concrete applications, such as adding new HE libraries and data processing algorithms.

Continuing with the Image Classifier embodiment of system 10, Apache Spark™, a unified analytics engine for large-scale data processing created by the Apache Software Foundation, was used as the basis to implement the distributed system. Spark is highly modularized, which simplifies its integration with other systems. Spark is an ideal distribution framework for system 10, as it enables the distribution of data as well as programs for execution on the cloud nodes (i.e., the untrusted processing nodes 26). In the Image Classifier embodiment of system 10, the PALISADE and SEAL HE libraries are used as the first libraries to be integrated with the system 10 framework. Both, PALISADE and SEAL, are implemented using C++ and provides a simple interface to access their basic functionality. The integration of these HE libraries into the system 10 framework required building a C++ wrapper to interact with the Django web server written in Python as well as the Spark interfaces used for the distribution. We used the Xen hypervisor to deploy a local instance of a cloud infrastructure as a service (IaaS). This local cloud served as a testbed to generate and manage virtual machines for the distributed system. We used this local cloud instance to deploy and test the Image Classifier embodiment of system 10.

The Image Classifier embodiment of system 10 was used to analyze the feasibility and performance of system 10. Image classification deals with labeling of images into predefined classes and training a classifier to classify a given image in one of those classes. Various machine learning classifiers can be used to classify images such SVM, K-Nearest Neighbors, Decision Tree, Convolutional Neural Networks, and Artificial Neural Networks. Image classification is useful in various application domains including autonomous driving, labeling x-ray images, and recognizing human faces for security purposes. For the Image Classifier embodiment of system 10, we used SVM and neural networks (NN) to implement two classifiers. The Image Classifier embodiment of system 10 includes two versions for each of the machine learning algorithms, corresponding to PALISADE and SEAL. In the following section, we describe the implementation of NN.

The specific NN we implemented in the Image Classifier embodiment of system 10 is the Feedforward Neural Network and trained it on the classic MNIST handwritten digit dataset. Each input to the network is a 64 value array representing one of the eight by eight images. The network was trained on plaintext data and then adapted to predict on encrypted data. The neural network consists of four layers. The input layer contains 64 neurons, with each neuron taking in one value from the 64-value input array. The second and third layers each consist of 128 neurons. This value was selected in this embodiment because it provided accurate prediction results on plaintext data but can be changed to optimize the calculation speed and accuracy of encrypted prediction results. The fourth and final layer is our output layer. The neuron with the highest activation in this layer is the Neural Network's final prediction. The sigmoid activation function was chosen since it can be adapted to operate on encrypted functions by representing it as a polynomial function. The following is an approximation of the sigmoid activation function used:

f(x)=0.500781+0.14670403x+0.001198x²−0:001006x³ (Equation 1)

We use cross-entropy to measure the distance between the predicted and actual probability distributions which is then used in back-propagation to adjust the network's weights and biases. Once the network is trained, encrypted data can be fed through the network using the sigmoid approximation function described above. The output can then be decrypted to see the network's prediction. In order to speed up the calculations, multiple inputs are distributed across the Spark cluster such that each node performs one prediction and returns the results.

The Image Classification embodiment of system 10 was implemented with two clients, User Client and Admin Client. Through the Admin Client GUI, among other functionalities, the admin can create nodes or virtual machines (VMs) and list the resources available on the distributed system. Likewise, through the User Client GUI, users can upload data, encrypt and decrypt data, and send encrypted data to the cloud for processing. During the operation of the application, after uploading the data, the user will have a set of standard machine learning algorithms to choose from to process the data. For example, in one embodiment of system 10, two algorithms, SVM and CNN, may be available to choose from. Once selected, the distributed machine learning algorithm with the HE implementation will be run on the distributed system that will then return the answer in encrypted form to be decrypted when needed.

Unlike previous approaches, system 10 provides a general framework for securing cloud analytics. System 10 improves the performance of analytic tools, implemented with HE, by distributing their executions in the cloud and providing a key management infrastructure for sharing the encrypted data. System 10 also differs from prior art efforts in that it enables FHE to be performed efficiently and it provides a framework to enable developers to use a variety of analytic tools which can be based on statistical analysis or other analytic techniques. Other prior art proposed techniques for securing machine learning algorithms are based on multiparty computation (MPC). Fundamentally, MPC requires interactive communications among the different nodes to perform the computations, whereas system 10 uses FHE to allow computations to be performed independently by the nodes. In addition, since FHE enables the computations to be performed without any key exchange, there is no overhead of secret sharing as in MPC. FHE allows for empowering a single party to take advantage of the cloud to securely analyze and share data with other parties.

System 10's approach of using FHE to provide data security during data processing addresses the shortcomings of standard cryptographic schemes such as the advanced encryption standards (AES) and Blowfish, and addresses some of the vulnerabilities of outsourcing data to the cloud. System 10 will enable organizations of all types and sizes to take advantage of large pools of computing resources available in the cloud without giving up the privacy of their data. The challenge with the existing HE schemes resides in the computation and storage overheads they incur. System 10 addresses the computation overhead by distributing the FHE computations across multiple nodes to reduce the computation time.

From the above description of the system 10, it is manifest that various techniques may be used for implementing the concepts of system 10 without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that system 10 is not limited to the particular embodiments described herein, but is capable of many embodiments without departing from the scope of the claims.

We claim:

1. A system for providing a secure, collaborative, and distributed computing environment as well as a repository for secure data storage and sharing, the system comprising:
a trusted client computer comprising a client manager, a fully homomorphic encryption (FHE) manager, and a configurations manager, wherein the client manager is software residing on the trusted client computer that is configured to manage all activities of the trusted client computer, wherein the FHE manager is software residing on the trusted client computer that is configured to generate and store encryption and decryption keys in a memory store and to perform all encryption and decryption functions on data, and wherein the configurations manager is software residing on the trusted client computer that is configured to track dynamically-changing cloud resources as the system is in use; and
an untrusted computing environment comprising an untrusted server and a plurality of untrusted, physical, distributed processing nodes, wherein the untrusted server comprises a distributed engine, an FHE manager configured to manage FHE processing operations in the processing nodes where no decryption or encryption functions occur at the processing nodes, a machine learning (ML) manager configured to manage ML algorithms in the processing nodes, a sharing manager configured to share encrypted data, and a configurations database, wherein the untrusted server is permitted to perform cloud management but not trusted to manipulate the data in plaintext thereby enabling collaborative and secure processing, editing, and merging of the data.

2. The system of claim 1, wherein the untrusted computing environment has a fully-connected graph of nodes topology.

3. The system of claim 1, wherein the untrusted computing environment has a ring topology.

4. The system of claim 1, wherein each processing node comprises an FHE library, a processor, and a memory store.

5. A method for increasing a speed of secure encrypted computing of big data in a cloud environment comprising the steps of:
modifying a machine learning, big data analytics engine to ensure that serialization and deserialization of cipher texts and context objects is performed such that the machine learning, big data analytics engine is configured to communicate with a homomorphic encryption software library so that the machine learning, big data analytics engines serves as a distributed machine learning library that is configured to perform machine learning and data analytics on the big data in the cloud;
modifying the homomorphic encryption software library to enable it to communicate with a plurality of computer nodes in the cloud environment such that the homomorphic encryption software library is not optimized for single node computations but is configured to impose fully homomorphic encryption (FHE) on a segment of the big data, wherein the homomorphic encryption software library is used as a core lattice cryptography library; and
using the distributed machine learning library and core lattice cryptography library to perform computations on the FHE data by implementing a support vector machine (SVM) algorithm to analyze the FHE data for classification and regression analysis on the plurality of computer nodes thereby enabling SVM classification on a large encrypted data set in a distributed fashion such that the speed of secure encrypted computing of big data is increased through parallelization of the secure encrypted computing across multiple nodes throughout the plurality of computer nodes.

6. A system for providing collaborative and secure data processing, editing, and merging as well as a repository for secure data storage and sharing, the system comprising:
a first trusted computer client comprising a fully homomorphic encryption (FHE) manager configured to create FHE data;
an untrusted cloud environment comprising an untrusted server communicatively coupled to a plurality of distributed, untrusted computer nodes;
a second trusted computer client comprising an FHE manager configured to decrypt FHE data;
wherein the untrusted server comprises a machine learning analytics engine that is communicatively coupled to a homomorphic encryption software library, wherein the untrusted server is configured to distribute at least a portion of the FHE data to the plurality of distributed untrusted computer nodes;
wherein the untrusted computer nodes are configured to perform data analytics in parallel directly on the FHE data without decrypting the FHE data, and wherein encrypted results of the data analytics are transmitted to the second trusted computer client via the untrusted server;
wherein the second trusted computer client is configured to decrypt the encrypted results;
wherein the first trusted computer client further comprises a cryptographic key manager that is configured to make use of a key management system based on public key infrastructure (PKI) in order to generate, store, distribute, and revoke public keys with respect to the untrusted cloud environment and to generate, store, distribute, and revoke private keys with respect to the second trusted computer client; and
wherein each of the first and second trusted computer clients further comprises an email server so as to enable an exchange of private keys between the first and second trusted computer clients using an email infrastructure.
